(19) United States
(12) Patent Application Publication
(10) Pub. No.: US 2025/0196762 A1
(43) Pub. Date: Jun. 19, 2025

(54) OPTICAL COMPONENT WITH MICRO-OPTICAL FEATURES

(71) Applicant: VALEO VISION, Bobigny (FR)

(72) Inventor: Colby DARLAGE, Seymour, IN (US)

(73) Assignee: VALEO VISION, Bobigny (FR)

(21) Appl. No.: 18/543,664

(22) Filed: Dec. 18, 2023

(51) Int. Cl. B60Q 1/50; F21V 8/00

(52) U.S. Cl. CPC B60Q 1/503; G02B 6/0036; G02B 6/006

(57) ABSTRACT

The present invention relates to an optical component for a vehicle lighting device. The optical component includes a substrate having at least one edge formed between a first surface and a second surface. Micro-optical features are provided on the first surface and a coating layer is applied on the first surface to cover the micro-optical features. When the optical component is edge lit by light source(s), the micro-optical features direct light received in the edge(s) outward through the second surface. In an unlit condition, the coating layer is visible through the transparent substrate and the lighting function is hidden. In a lit condition, the micro-optical features direct light coming from the light source(s), thereby illuminating the substrate to create desired lighting effect/function.

### TECHNICAL FIELD

The present invention relates to an optical component for a vehicle lighting device, and more particularly to an optical component having micro-optical features.

### BACKGROUND OF THE INVENTION

Lighting devices are being used in motor vehicles to perform various functions such as glowing logos, illuminated grills, illuminated handles, styling/decorative purposes, signature functions etc.

There is increased requirement of see through optical components. These “see through optical components” such as transparent chrome or transparent metallization require very precise processing to ensure that the chrome/metallization allows light from rear side of the component to uniformly pass through them.

### BRIEF SUMMARY OF THE INVENTION

An object of the present invention is to solve the disadvantages described above of known optical component(s). In particular, an object of the present invention is to provide an optical component with micro-optical features.

Another object of the present invention is to provide an optical component for a vehicle lighting device, with a lighting function that is hidden when the light source(s) is/are unlit.

In this context, the present invention is directed towards an optical component including a substrate, micro-optical features and a coating layer. The substrate has a first surface, a second surface and plurality of edges between the first surface and the second surface. The micro-optical features are provided on the first surface. The coating layer is applied on the first surface, covering the micro-optical features, with the micro-optical features being adapted to direct light received in at least one of the plurality of edges outward through the second surface. The micro-optical features are not visible when no light is received in the edge(s) of the substrate. When light is received in at least one of the edges, the micro-optical features direct light outward, thereby illuminating the substrate to create desired lighting effect(s)/function(s).

In a non-limiting embodiment of the present invention, the coating layer includes any of the metallic coating, paint, film or chrome. So, in unlit condition desired appearance of the optical component is achieved.

In a non-limiting embodiment of the present invention, the coating layer is opaque, semi-transparent or colored transparent.

In a non-limiting embodiment of the present invention, the coating layer has a predefined color. So, desired colored appearance is achieved for the optical component, as per styling requirements.

In a non-limiting embodiment of the present invention, the micro-optical features include any of the micro pillows, micro cones, non-uniform optics, micro directional optics or micro textures. It is to be understood that any other functionally similar micro-optical features may be provided on the optical component, to achieve similar results.

In a non-limiting embodiment of the present invention, the micro-optical features are integrally molded on the first surface.

In a non-limiting embodiment of the present invention, the substrate is an optically transparent lens. The lens may be made from clear plastic, Polycarbonates (PC), acrylic or any other suitable optically transparent material.

In a non-limiting embodiment of the present invention, the substrate has a flat shape. The flat shape may have any polygonal or circular configuration.

In an alternate embodiment of the present invention, the substrate has a predefined curved shape. The degree of the curvature of the curved substrate may be selected such that the desired functionality of the optical component is achieved, with negligible light leakage.

The present invention also relates to a lighting device for a motor vehicle. The lighting device includes a substrate, micro-optical features, a coating layer and at least one light source. The substrate has a first surface, a second surface and plurality of edges between the first surface and the second surface. The micro-optical features are provided on the first surface. The coating layer is applied on the first surface, covering the micro-optical features. The at least one light source is adapted to emit light through at least one of the plurality of edges, with the micro-optical features being adapted to direct the light coming from the at least one light source outward through the second surface. The micro-optical features are not visible when the at least one light source is not lit, as no light is received in the edge(s) of the substrate. When the at least one light source is lit, the micro-optical features direct light received in the edge(s) outward, thereby illuminating the substrate to create desired lighting effect(s)/function(s).

In a non-limiting embodiment of the present invention, the coating layer includes any of the metallic coating, paint, film or chrome. So, in unlit condition desired appearance of the optical component is achieved.

In a non-limiting embodiment of the present invention, the coating layer is opaque, semi-transparent or colored transparent.

In a non-limiting embodiment of the present invention, the coating layer has a predefined color. So, desired colored appearance is achieved for the optical component, as per styling requirements.

In a non-limiting embodiment of the present invention, the micro-optical features include any of the micro pillows, micro cones, non-uniform optics, micro directional optics or micro textures. It is to be understood that any other functionally similar micro-optical features may be provided on the optical component, to achieve similar results.

In a non-limiting embodiment of the present invention, the micro-optical features are integrally molded on the first surface.

In a non-limiting embodiment of the present invention, the substrate is an optically transparent lens. The lens may be made from clear plastic, Polycarbonates (PC), acrylic or any other suitable optically transparent material.

In a non-limiting embodiment of the present invention, the substrate has a flat shape. The flat shape may have any polygonal or circular configuration.

In an alternate embodiment of the present invention, the substrate has a predefined curved shape. The degree of the curvature of the curved substrate may be selected such that the desired functionality of the optical component is achieved, with negligible light leakage.

In a non-limiting embodiment of the present invention, the at least one light source emits light of a predefined color. The plurality of light sources may emit light of different predefined colors. The color(s) of the light may be selected as per the requirements of desired lighting function or plurality of different lighting functions.

The present invention also relates to a lighting device for a motor vehicle. The lighting device includes a substrate, micro-optical features, a coating layer and at least one light source. The substrate has a first surface, a second surface and a single edge between the first surface and the second surface. The micro-optical features are provided on the first surface. The coating layer is applied on the first surface and covers the micro-optical features. The at least one light source is adapted to emit light through the single edge, with the micro-optical features being adapted to direct the light coming from the at least one light source outward through the second surface. The micro-optical features are not visible when the at least one light source is not lit, as no light is received in the single edge of the substrate. When the at least one light source is lit, the micro-optical features direct light received in the single edge outward, thereby illuminating the substrate.

In a non-limiting embodiment of the present invention, a mask is applied on at least a portion of the second surface. The mask may be a single layer having one or more openings of predefined shapes. Thus when the mask is applied on the second surface of the substrate, unmasked area i.e., area of the second surface corresponding to the opening(s) of the mask forms the shape of logo. The logo may include letter(s), symbol(s) etc. Alternatively, the mask may include plurality of segments that may be applied on the second surface and arranged in a predefined manner such that the area(s) of the second surface in the shape of logo, remains unmasked.

In a non-limiting embodiment of the present invention, the mask and the coating layer have same color. So that the unmasked area of the second surface is not distinguishable thereby hiding the logo, when the light source(s) is/are not lit.

In an alternate embodiment of the present invention, the mask and the coating layer have different colors. So that the logo is visible in the color of the coating layer, when the light source(s) is/are not lit.

In a non-limiting embodiment of the present invention, the micro-optical features include any of the micro pillows, micro cones, non-uniform optics, micro directional optics or micro textures. It is to be understood that any other functionally similar micro-optical features may be provided on the optical component, to achieve similar results.

In a non-limiting embodiment of the present invention, the at least one light source emits light of a predefined color. The colors of the coating layer, the mask and the light source(s) may be suitable selected to achieve the desired lighting effect.

### BRIEF DESCRIPTION OF THE DRAWINGS

The present invention is expounded in detail below with the aid of the presented drawings. In the drawings:

FIG. 1A illustrates an isometric view of an optical component, according to an embodiment of present invention;

FIG. 1B illustrates an exploded view of the optical component with a coating layer separated from a substrate, according to an embodiment of present invention;

FIG. 1C illustrates a cross-sectional view of the optical component taken along line A-A in FIG. 1A, according to an embodiment of present invention;

FIG. 2A illustrates the optical component with light source(s) provided at a first edge of the substrate, according to an embodiment of present invention;

FIG. 2B illustrates the optical component with light source(s) provided at a second edge of the substrate, according to an embodiment of present invention;

FIG. 2C illustrates the optical component with light source(s) provided at the first and the second edges of the substrate, according to an embodiment of present invention;

FIG. 2D illustrates the optical component with light source(s) provided at a third edge of the substrate, according to an embodiment of present invention;

FIG. 2E illustrates the optical component with light source(s) provided at a fourth edge of the substrate, according to an embodiment of present invention;

FIG. 2F illustrates the optical component with light source(s) provided at the third and the fourth edges of the substrate, according to an embodiment of present invention;

FIG. 2G illustrates the optical component with light source(s) provided at the first, second, third and fourth edges of the substrate, according to an embodiment of present invention;

FIG. 3A illustrates an illuminating logo/emblem, according to an embodiment of present invention;

FIG. 3B illustrates a cross-sectional view of the illuminating logo taken along line B-B in FIG. 3A, according to an embodiment of present invention;

4A illustrates an illuminating logo/emblem, according to an embodiment of present invention; and

4B illustrates a cross-sectional view of the illuminating logo taken along line C-C in FIG. 4A, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

In the following description, the expression, “first surface” refers to rear surface of the substrate and the expression, “second surface” refers to front surface of the substrate, when the optical component is assembled in the vehicle lighting device.

The present invention relates to an optical component for a lighting device. The lighting device is provided on a motor vehicle to perform lighting functions such as illuminating logo/badge, illuminating grills, illuminating handles, styling/decorative purposes, signature functions, and/or other lighting functions. The lighting function remains hidden when the lighting device is turned OFF and becomes visible only when light source(s) of the lighting device is/are lit. The optical component of the lighting device includes a substrate, preferably a transparent substrate such as optical lens. The optical component further includes micro-optical features such as micro pillows, micro cones, non-uniform optics, micro directional optics, micro textures etc., provided on a first surface of the substrate. A coating layer such as metallic coating, paint, film, chrome etc., is applied on the first surface and covers the micro-optical features. The substrate includes at least one edge formed between the first surface and a second surface. One or more light sources are provided at to emit light in at least one of the edges the substrate. In an unlit condition i.e., when the light source(s) are turned OFF, the micro-optical features cannot be seen and the coating layer is visible through the transparent substrate. When the light source(s) is/are turned ON, the micro-optical features direct the light received in the edge(s) outward through the second surface, thereby illuminating the substrate to create desired lighting effect/function.

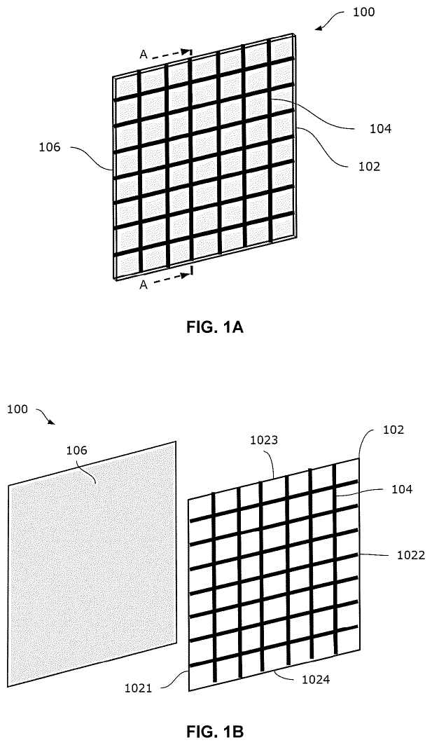

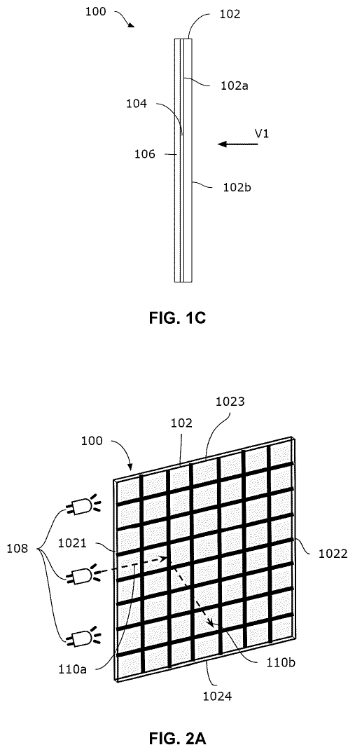

FIGS. 1A-1C illustrate an optical component 100 including a substrate 102 having a first surface 102a and a second surface 102b (shown in FIG. 1C). Micro-optical features 104 are provided on the first surface 102a of the substrate 102. Further, a coating layer 106 is applied on the first surface 102a, covering the micro-optical features 104. The substrate 102 has plurality of edges formed between the first surface 102a and the second surface 102b. In one embodiment, as shown in FIG. 1B, the substrate 102 includes a first edge 1021, a second edge 1022, a third edge 1023 and a fourth edge 1024. However, it is to be understood that the substrate 102 may have any polygonal or circular configuration or may have curved edges, and the edge(s) can be defined for these configurations accordingly.

As shown in cross-section of the optical component 100 in FIG. 1C, the micro-optical features 104 provided on the first surface 102a of the substrate 102, are covered with the coating layer 106. So, when viewed from front direction V1, the coating layer 106 is at rear side of the substrate 102. As shown in FIG. 1A, the micro-optical features 104 direct the light 110a entering the substrate 102 from any of the edges 1021, 1022, 1023, 1024 outward through the second surface 102b of the substrate 102 shown by dotted arrow 110b. When no light is received in any of the edges 1021, 1022, 1023, 1024, the micro-optical features 104 are not visible and the coating layer 106 is visible through the substrate 102.

In another embodiment of the present invention, there is provided a vehicle lighting device (not shown) including the substrate 102 and at least one light source 108 provided to emit light in at least one of the edges 1021, 1022, 1023, 1024 of the substrate 102.

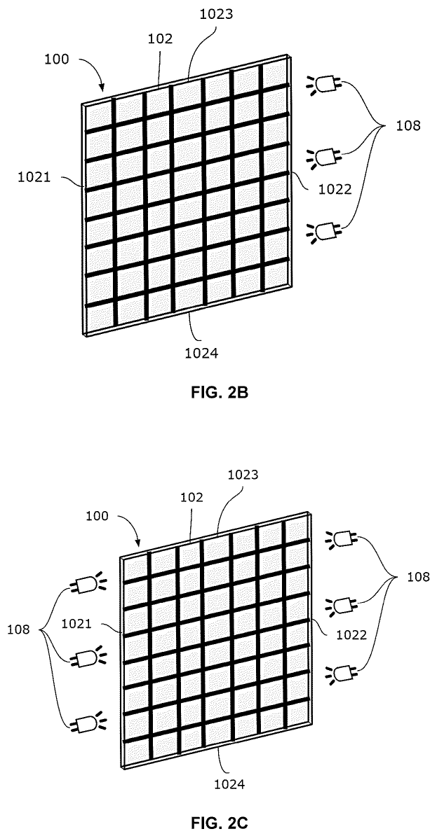

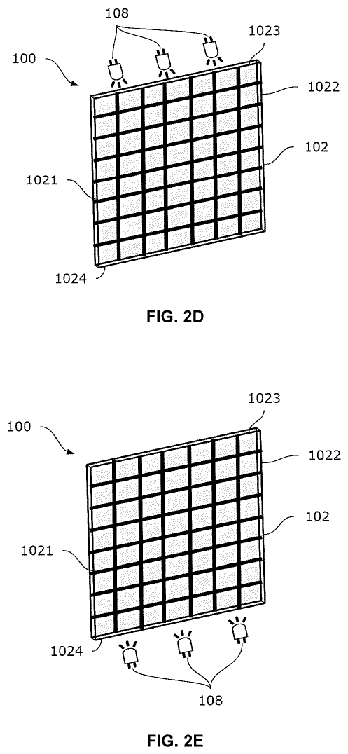

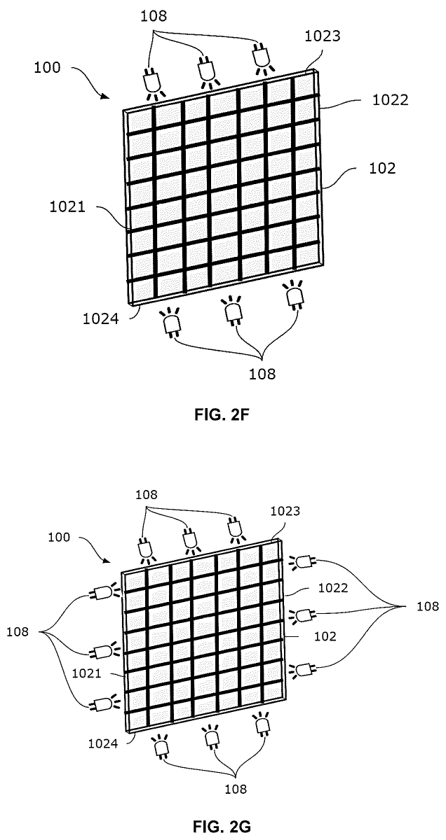

FIGS. 2A-2G illustrate different configurations of light source(s) 108 provided to illuminate at least one of the plurality of edges of the substrate 102. FIGS. 2A, 2B, 2D and 2E show light source(s) 108 provided at the first edge 1021, the second edge 1022, the third edge 1023 and the fourth edge 1024 of the substrate 102, respectively. FIG. 2C shows light source(s) 108 provided at the first edge 1021 and the second edge 1022 of the substrate 102. Similarly, FIG. 2F shows light source(s) 108 provided at the third edge 1023 and the fourth edge 1024 of the substrate 102. FIG. 2G shows light source(s) 108 provided at the first edge 1021, the second edge 1022, the third edge 1023 and the fourth edge 1024. It is to be understood that the number of light sources 108 corresponding to each of the edges 1021, 1022, 1023, and 1024 may be varied as per the requirement. Light emitted by the light source(s) 108 enters the optical component 100 through at least one of the edges 1021, 1022, 1023, 1024. The micro-optical features 104 provided on the first surface 102a, direct the light outward through the second surface 102b to illuminate the substrate.

In a preferred embodiment, the substrate 102 is transparent. Thus, when the light source(s) 108 is/are turned OFF i.e., in an unlit condition, the micro-optical features 104 provided on the first surface 102a are not visible. The coating layer 106 is visible through the transparent substrate 102. So, the lighting function of the optical component 100 is hidden in the unlit condition.

In lit condition i.e., when at least one of the light sources 108 is turned ON, light from the light source(s) 108 enters the substrate 102 through corresponding edge(s), as shown by dotted arrow 110a in FIG. 2A. Any known coupling means (not shown) can be used with the light source(s). The micro-optical features 104 direct the light 110a coming from the light source(s) 108 outward, as shown by dotted arrow 110b in FIG. 2A. The light 110b directed by the micro-optical features 104 travels in a direction opposite to the coating layer 106, through the second surface 102b of the transparent substrate 102. Thus, the substrate 102 glows to create desired lighting effect/function.

In an embodiment of the present invention, the coating layer 106 may be any of metallic coating, paint, film or chrome. The coating layer 106 may be applied to the micro-optical features 104, by any known means. In unlit condition, the coating layer 106 is visible through the substrate 102, so that the lighting function remains hidden.

In another embodiment of the present invention, the coating layer 106 can be opaque or semi-transparent or colored transparent. Further, the coating layer 106 of any predefined color may be provided to enhance appearance and styling of the lighting module. The transparency level and color of the coating layer 106 may be selected based on the requirements of the lighting function.

In another embodiment of the present invention, the micro-optical features 104 may include any of the known micro-optics such as micro pillows, micro cones, non-uniform optics, micro directional optics or micro textures etc. Any other type of micro-optical features 104 may be provided on the substrate 102. The micro-optical features 104 provided on the substrate 102 are not generally visible due to their micron and submicron scale.

In an embodiment of the present invention, the micro-optical features 104 are molded in the substrate 102 on the first surface 102a.

In an embodiment of the present invention, the substrate 102 is an optically transparent lens. The transparent lens/substrate 102 may be made from clear plastic, Polycarbonates (PC), acrylic or any other suitable optically transparent material.

In an embodiment of the present invention, the substrate 102 has a flat shape as shown in the FIGS. 1A-2G. In an alternate embodiment, the substrate 102 may have a predefined curved shape. Degree of curvature of the substrate 102 may be selected such that the desired lighting function is achieved with negligible light leakage.

In an embodiment of the present invention, the light source(s) 108 emits light having predefined color, as is suitable to the lighting function. The plurality of light sources 108 may emit light of different colors, as per the requirement. The combination of the color of the coating layer 106 and that of light emitted by the light source(s) 108 may be selected such that lighting effect/function of desired color or plurality of different lighting effects are created.

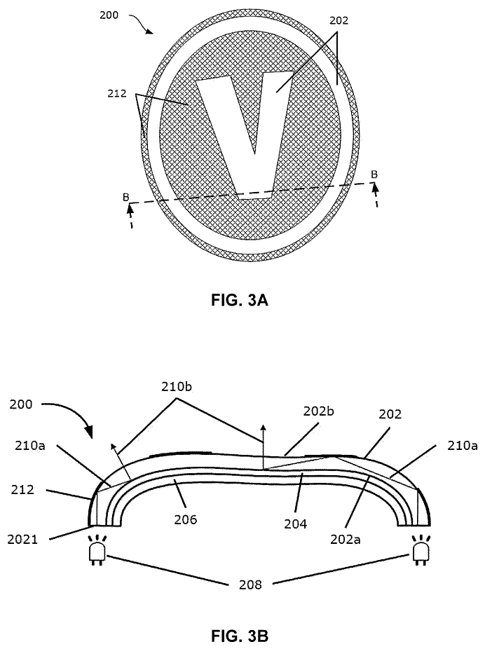

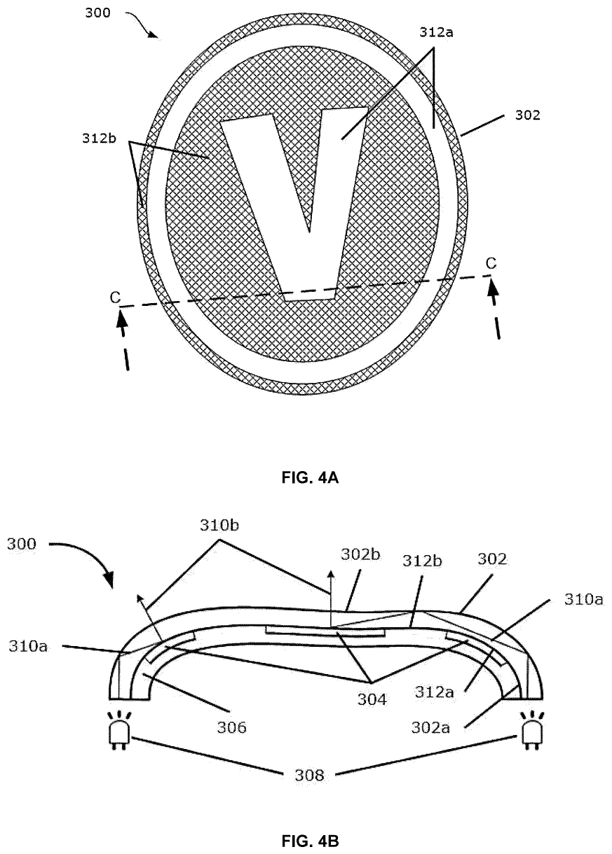

In another exemplary embodiment of the present invention, an optical component 200 is provided as an illuminating logo/badge/emblem, as shown in FIGS. 3A and 3B. The component 200 includes a transparent substrate 202 with micro-optical features 204 provided on a first surface 202a of the substrate 202. A coating layer 206 is applied on the first surface 202a and covers the micro-optical features 204. The component 200 includes a single edge 2021 formed between the first surface 202a and a second surface 202b. The micro-optical features 204 may include any of the micro pillows, micro cones, non-uniform optics, micro directional optics or micro textures etc.

Further, the component 200 includes a mask 212 provided on the second surface 202b of the substrate 202. The mask 212 includes opening(s) or cutouts of a predefined shape(s) and size(s) such that the mask 212 covers the area of the second surface 202b that is not required to be illuminated. The micro-optical features 204 are not visible and the coating layer 206 is visible through the opening(s) of the mask 212 i.e., through unmasked area of the second surface 202b of the substrate 202.

At least one light source 208 may be provided to emit light in the substrate 202 through the edge 2021. When light 210a is received in the edge 2021, micro-optical features 204 direct the light outward through the second surface 202b. However, the mask 212 prevents the light from exiting through masked surface of the substrate 202 and the light 210b exits through the areas of the second surface 202b which are not covered by the mask 212. Thus, in lit condition, only the area of the substrate 202 that is not covered by the mask 212 glows. The mask 212 may have any predefined color.

In an embodiment of the present invention, the color of the coating layer 206 and the color of the mask 212 are different. So, in unlit condition, the logo is visible with the color of the coating layer 206.

In an alternate embodiment of the present invention, the coating layer 206 and the mask 212 have same color. Thus, in unlit condition, the logo is hidden and cannot be distinguished from the mask 212.

In an embodiment of the present invention, the at least one light source 208 may emit light of a predefined color. Alternatively, plurality of light sources 208 may emit light of different colors to create desired lighting effect. The combination of colors of the coating layer 206, the mask 212 and the light source(s) 208 may be suitably selected as per the requirements of desired lighting function or plurality of different lighting functions.

In an embodiment of the of the present invention, the mask 212 may include a single layer with predefined opening(s) or multiple segments that can be applied on predefined areas of the second surface 202b.

In another exemplary embodiment of the present invention, an optical component 300 is provided as an illuminating logo/badge/emblem, as shown in FIGS. 4A and 4B. The component 300 includes a transparent substrate 302 having a first surface 302a and a second surface 302b. Micro-optical features 304 are provided on at least a portion of the first surface 302a of the substrate 302. A coating layer 306 is applied on the first surface 302a and covers the micro-optical features 304. The micro-optical features 304 may include any of the micro pillows, micro cones, non-uniform optics, micro directional optics or micro textures etc.

As shown in FIG. 4A, the micro-optical features 304 may be provided on a first region 312a of the first surface 302a. The first region 312a may include any predefined shape(s) such as logo, badge, emblem etc. The first surface 302a has a second region 312b not having any micro-optical features. When, the coating layer 306 is applied on the first surface 302a, it covers the micro-optical features 304 provided in the first region 312a and covers the second region 312b. When no light is received in the substrate 302, the coating layer 306 is visible through the transparent substrate 302, in both the first region 312a and the second region 312b. Thus, the shape(s) of the first region 312a is hidden.

At least one light source 308 may be provided to emit light in the substrate 302 as shown in FIG. 4B. When light 310a is received in the substrate 302, micro-optical features 304 provided in the first region 312a direct the light outward through the second surface 302b. However, the second region 312b does not direct the light outwards due to absence of micro-optical features. So, the light 310b exiting the second surface 302b is the light directed by the micro-optical features 304 provided on the first region 312a. Thus, in lit condition, only the first region 312a glows. Therefore, only the shape(s) corresponding to the first region 312a of the substrate 302 illuminates.

In an embodiment of the present invention, the first region 312a may include plurality of segments that are distinct or interconnected with each other to form a predefined shape that is required to glow in lit condition to crate the effect of illuminated logo.

In an embodiment of the present invention, the coating layer 306 may have a predefined color. Thus, in unlit condition, the micro-optical features 304 are not visible and the logo is hidden and cannot be distinguished from the coating layer 306. In lit condition, only the logo is illuminated and the coating layer 306 may be visible in only the area that is not illuminated, thus creating desired lighting effect.

In an embodiment of the present invention, the at least one light source 308 may emit light of a predefined color. Alternatively, plurality of light sources 308 may emit light of different colors to create desired lighting effect. The combination of colors of the coating layer 306 and the light source(s) 308 may be suitably selected as per the requirements of desired lighting function or plurality of different lighting functions.

In an embodiment of the present invention, the colors of the coating layer 306 and the light source(s) 308 are selected such that when lit, they in combination, form the logo with predefined elements i.e. elements of the logo associated with the first region 312a, being illuminated.

The invention shall not, however, be limited to the means and configurations described and illustrated herein, and shall also extend to any equivalent means or configuration described and illustrated herein, and to any technical combination operating such means.

LIST OF REFERENCE SIGNS

| | |
|---|---|
| 100, 200, 300 | Optical component |
| 102, 202, 302 | Substrate |
| 102a, 202a, | First surface |
| 302a | |
| 102b, 202b, | Second surface |
| 302b | |
| 104, 204, 304 | Micro-optical features |
| 106, 206, 306 | Coating layer |
| 1021 | First edge |
| 1022 | Second edge |
| 1023 | Third edge |
| 1024 | Fourth edge |
| 2021 | Single edge |
| 108, 208, 308 | Light source(s) |
| 110a, 110b, | Light |
| 210a, 210b, | |
| 310a, 310b | |
| 212 | Mask |
| 312a | First region |
| 312b | Second region |

1. An optical component, comprising:
a substrate having a first surface, a second surface and plurality of edges between the first surface and the second surface;
micro-optical features provided on the first surface, with the micro-optical features not being visible because of being a micro scale; and
a non-transparent coating layer directly applied on the first surface and covering the micro-optical features, with the micro-optical features being configured to direct light received in at least one of the plurality of edges outward through the second surface, with the light traveling through the substrate by total internal reflection.

2. The optical component according to claim 1, wherein the coating layer includes any of the metallic coating, paint, film or chrome.

3. The optical component according to claim 1, wherein the coating layer is opaque, semi-transparent or colored transparent.

4. The optical component according to claim 1, wherein the coating layer is non-reflective.

5. The optical component according to claim 1, wherein the micro-optical features include any of the micro pillows, micro cones, non-uniform optics, micro directional optics or micro textures.

6. The optical component according to claim 1, wherein the micro-optical features are integrally molded on the first surface.

7. The optical component according to claim 1, wherein the substrate is an optically transparent lens.

8. The optical component according to claim 1, wherein the substrate has a flat shape.

9. The optical component according to claim 1, wherein the substrate has a predefined curved shape.

10. A lighting device for a motor vehicle, comprising:
a substrate having a first surface, a second surface and plurality of edges between the first surface and the second surface;
micro-optical features provided on the first surface, with the micro-optical features not being visible because of being a micro scale;
a non-transparent coating layer directly applied on the first surface and covering the micro-optical features; and
at least one light source configured to emit light through at least one of the plurality of edges, with the light traveling through the substrate by total internal reflection, with the micro-optical features being configured to direct the light coming from the at least one light source outward through the second surface.

11. The lighting device according to claim 10, wherein the coating layer includes any of the metallic coating, paint, film or chrome.

12. The lighting device according to claim 10, wherein the micro-optical features include any of the micro pillows, micro cones, non-uniform optics, micro directional optics or micro textures.

13. The lighting device according to claim 10, wherein the micro-optical features are integrally molded on the first surface.

14. The lighting device according to claim 10, wherein the at least one light source emits light of a predefined color.

15. A lighting device for a motor vehicle, comprising:
a substrate having a first surface, a second surface and a single edge between the first surface and the second surface;
micro-optical features provided on the first surface, with the micro-optical features not being visible because of being a micro scale;
a non-transparent coating layer directly applied on the first surface and covering the micro-optical features; and
at least one light source configured to emit light through the single edge, with the light traveling through the substrate by total internal reflection, with the micro-optical features being configured to direct the light coming from the at least one light source outward through the second surface.

16. The lighting device according to claim 15, wherein a mask is applied on at least a portion of the second surface.

17. The lighting device according to claim 16, wherein the mask and the coating layer have same color.

18. The lighting device according to claim 16, wherein the mask and the coating layer have different colors.

19. The lighting device according to claim 16, wherein the micro-optical features include any of the micro pillows, micro cones, non-uniform optics, micro directional optics or micro textures.

20. The lighting device according to claim 16, wherein the at least one light source emits light of a predefined color.
